(19) United States
(12) Patent Application Publication
(10) Pub. No.: US 2005/0122532 A1
(43) Pub. Date: Jun. 9, 2005

(54) Apparatus for color processing and method thereof

(75) Inventors: Hui-Huang Chang, Hsinchu (TW); Cheng-Hsin Chang, MaTou Town (TW); Hsin-Ying Ou, KaoHsiung (TW)

Correspondence Address: BRUCE H. TROXELL, SUITE 1404, 5205 LEESBURG PIKE, FALLS CHURCH, VA, 22041, US

(73) Assignee: Realtek Semiconductor Corp.

(21) Appl. No.: 10/726,657

(22) Filed: Dec. 4, 2003

(51) Int. Cl. H04N 1/60

(52) U.S. Cl. 358/1.9; 358/523

(57) ABSTRACT

A method and an apparatus for color processing, that a cache is used along with the characteristic of neighboring similarity of image for reducing size of integrated circuit (IC) and accelerating color processing speed. The apparatus comprises: a color processor for doing conversions and operations between colors; a color table for storing all the color data; and a cache connecting the color processor and the color table for storing a portion of color data and providing the color data to the color processor, and thereafter, refreshing the color data stored in the cache when needed.

### BACKGROUND OF THE INVENTION

(a). Field of the Invention

The present invention relates to an apparatus for image processing and a method thereof, and more particularly to an apparatus for color processing and a method thereof.

(b). Description of the Prior Arts

In recent years, in associated with the progress of image technology, the request for higher image quality from users has become more and more demanding. The requisition to realize high quality imaging, including good color representation, high image resolution, and rapid image formation, etc., is overwhelming.

The color model is for defining colors. There are two color models: the RGB (red-green-blue) model which the color is reproduced by adding the three primary RGB colors in varying proportions (which is called additive mixing) and the CMYK (cyan-magenta-yellow-black) model which the color is reproduced by subtraction of one of the components from white light (which is called subtractive mixing).

Color printers are based on 4-color printing, using black (K), in addition to the three primary colors of cyan (C), magenta (M), and yellow (Y). Theoretically, black can be produced by mixing the three CMY colors. However, due to the difficulty in achieving pure black, it's common to add black as the fourth color for printing. Currently six- and seven-color printers are also available. The color model having additional light cyan (C′) and light magenta (M′) along with the original cyan (C), magenta (M), yellow (Y), and black (K) is called CMYKC′M′ model which can produce better and more vibrant color image.

An image displayed on a monitor using the three RGB primary colors must be converted to CMYK or CMYKC′M′ for printing. Each printer comes with printer driver software that converts color images created on the computer into a data format that can be processed by the color printer. However, while converting from RGB colors to CMY is straightforward, converting to CMYK is not, not to mention converting to CMYKC′M′. Usually a color table is used for the conversion between RGB system and the CMYK system or CMYKC′M′ system, nevertheless, the color table using 3-D interpolation will occupy a great many memory space. That is, a typical computer display can produce colors with 2⁸ brightness values for each of the red, green, and blue components to produce a total of 2²⁴ different colors that are far more than the human eye can distinguish. Therefore, it is common to use a 3-bit RGB system for displaying, i.e. a computer display with 2³ brightness values for each of the red, green, and blue components. Under the circumstances, a color table that converts the RGB system to the 6-color CMYKC′M′ system, by using the respective 2³ brightness values of RGB as index corresponding to the CMYKC′M′, will occupy 9×9×9×6=4374 bytes (2³+1=9, wherein the value 1 is added for representing 0 state). Similarly, converting a 4-bit RGB system to the 6-color CMYKC′M′ system will occupy 17×17×17×6=29478 bytes, and converting a 5-bit RGB system to the 6-color CMYKC′M′ system will occupy 33×33×33×6=215622 bytes. Please refer to FIG. 2A and FIG. 2B. If the color table 2 is built within the color processing IC 1, the color table 2 will consume pretty large IC area. As seen in FIG. 2A, a color processing IC comprises a color processor 11 and a color table 2, that the color processor 11 and the color table 2 respectively is connected to a bus 12. In this way, though the processing speed is increased, but the fabricating cost will be increased a lot due to the increase of IC area. On the other hand, as seen in FIG. 2B, if the color table 2 is built outside the color processing IC 1, and a bus 12 is used for connecting the color processor 11 and the color table 2, the bus 12 will substantially reduce the color processing speed, as seen in FIG. 2B. Please refer to FIG. 3, which is a 3-D diagram illustrating the operation principle of the color processor. Take a 3-dimention cube for instance, in order to obtain the color represented by the coordinate of the center of the cube, which is not conveniently available on the color table, the coordinates of the eight end points of the cube are used in the calculation. Using the simple linear interpolation method, the formula is as following:
P_{center}=Inter{Inter[Inter(P₀, P₁)], Inter [(P₂, P₃)], Inter[Inter(P₄, P₅)Inter(P₆, P₇)]}
Inter (x1, x2): representing an operation for taking the average value of x1 and x2.

During the operation, the 6-color CMYKC′M′ representations of the eight end points are required to be read from the color table first, that is about the total of 48 bytes (6×8=48). For the bandwidth that can access 96 MB data per second, the external color table can only provide a pixel processing capability of 2M per second (96M/48=2M). Since the current high-speed requirement of color processing is at least 10M per second, obviously the aforementioned external color table can not meet the requirement.

### SUMMARY OF THE INVENTION

The primary goal of the present invention is to provide a method and apparatus for color processing that can increase processing speed so as to achieve high performance color processing.

The secondary goal of the present invention is to provide a method and apparatus for color processing that will not consume too much IC area so as to reduce fabricating cost.

In order to achieve the aforementioned goals, the present invention provides a method for color processing realized by a color processing apparatus, which comprises a color table for storing a plurality of color data, and a cache memory for caching part of the color data. The method comprises the steps of: issuing a color index; returning the color data corresponding to the color index from cache if the color data is cached in the cache memory; and returning the the color data from the color table if the color data is not cached in the cache memory.

The present invention also provides an integrated circuit (IC) for accelerating color processing coupled to an external color table storing a plurality of color data. The IC comprises: a color processor performing color conversions and operations; and a cache coupling the color table and the color processor and storing at least one of the color data selected from the color table. The color processor issues a color index to search for a corresponding one of the color data from the cache. Then, the corresponding one of the color data is loaded from the color table into the cache if the corresponding one of the color data is not found in the cache.

### BRIEF DESCRIPTION OF THE DRAWINGS

FIG. 1 is a relation diagram of the three primary colors.

FIG. 2A is a schematic diagram showing a color table that is built within the color processing IC.

FIG. 2B is a schematic diagram showing a color table that is built outside the color processing IC.

FIG. 3 is a color of the image representing by a 3-D image cube.

FIG. 4 is a schematic diagram showing an apparatus of the embodiment of the present invention.

FIG. 5 is a flow chart featuring an operation according to the embodiment of the present invention.

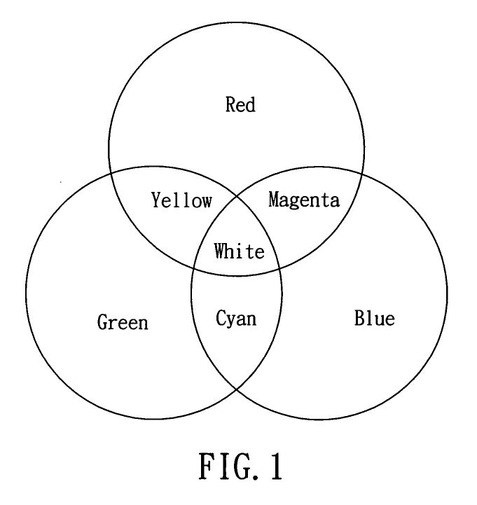

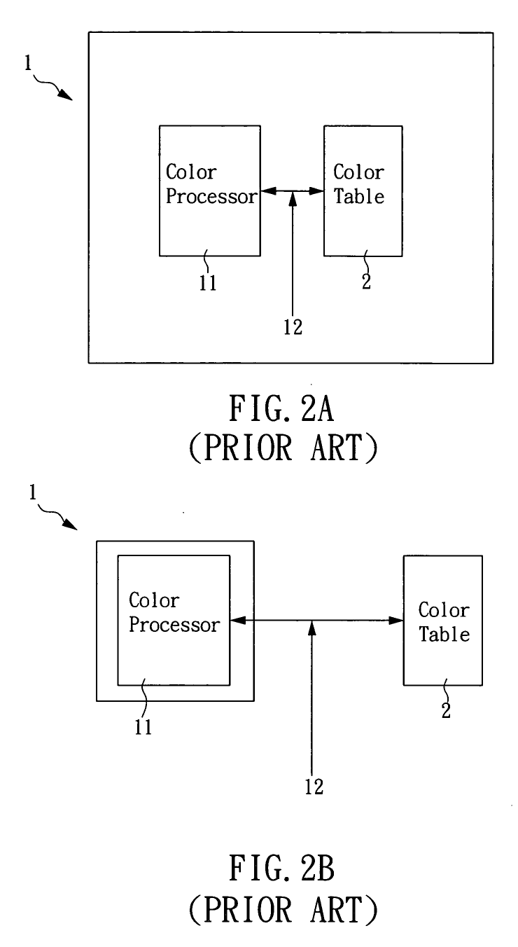

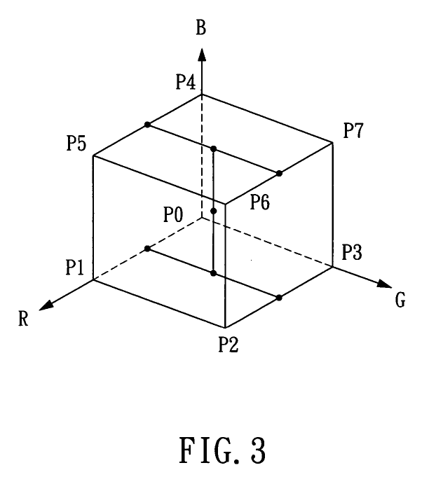

### DETAILED DESCRIPTION OF THE PRESENT INVENTION

The objects, spirits and advantages of the preferred embodiments of the present invention will be readily understood by the accompanying drawings and detailed descriptions, wherein:

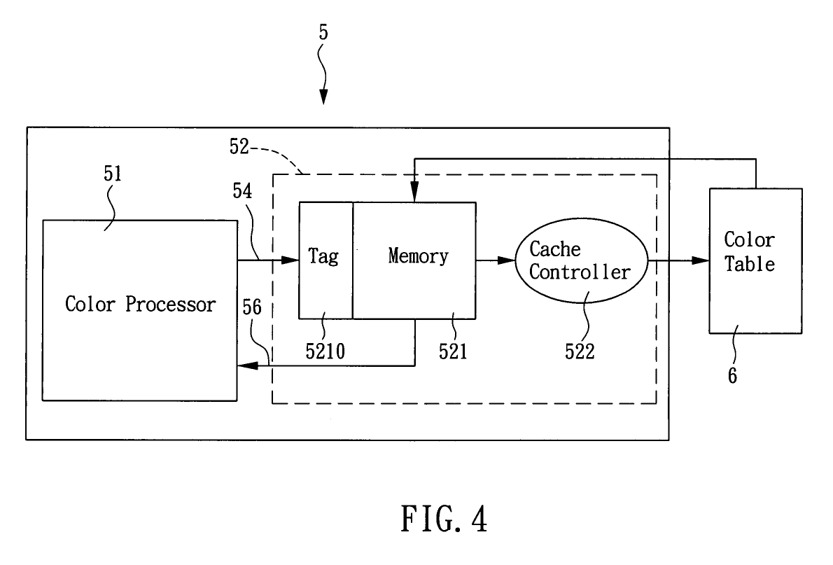

In most cases, the color difference within a small area of the image is not too drastic. Therefore, a storage device can be used to store a portion of color data in correspondence to the need of high-performance calculation. Please refer to FIG. 4, which is a schematic diagram showing an apparatus disclosed in the embodiment of the present invention. A high performance color processing apparatus according to the embodiment of the present invention comprises: a color processor 51 for doing conversions and operations between colors; a color table 6 for storing all the color data; and a cache 52, which is coupled the color processor 51 and the color table 6 for storing a portion of the color data for used by the color processor 51. The color data stored in the cache 52 is timely refreshed. The cache 52 further comprises: a memory 521, which is coupled to the color processor 51 for storing a portion of the color data; a cache controller 522, which is coupled to the memory 521 and the color table 6 for loading a designated color data from the color table 6 into the memory 521 when the color processor 51 can not find the designated color data inside the memory 521 so as to provide the designated color to the color processor 51. The memory 521 further comprise a plurality of tags 5210 for accelerating the comparison inside the cache 521. In the embodiment, all the foregoing units, except for the color table 6, are packaged inside a component, such as an IC 5. The aforementioned apparatus not only can reduce the size of the IC 5 and increase processing speed, but also can save the resource of the system by sharing the external color table 6 with other devices.

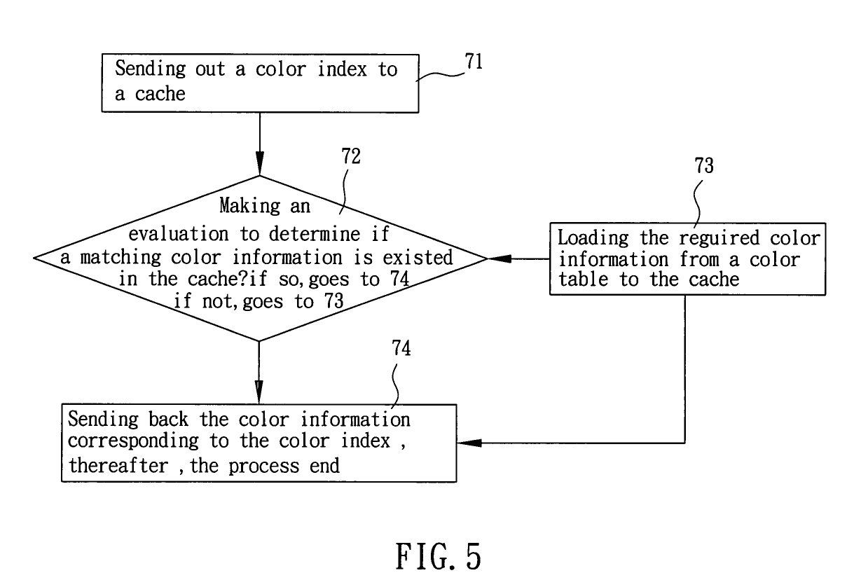

Please refer to FIG. 5, which is a flow chart featuring an operation according to the embodiment of the present invention.

71: Sending out a color index 54 to a cache 52, i.e. when a color processor 51 requires color data during color processing, a color index 54 will be sent out by the color processor 51 to the cache 52.

72: Making an evaluation to determine whether a matching color data exists in the cache 52 or not; if so, goes to step 74; if not, goes to step 73. That is, when the color index 54 is received by the cache 52, a comparison is made to determine whether a color data matching with the color index is available in the cache 52 or not? In order to accelerate the comparison, a plurality of tags 5210 is used.

73: Loading the required color data from the color table 6 to the cache 52; if the result of the comparison is that the required color data does not exist in the cache 52, then the required color data will be loaded from the color table 6 to the cache 52 by way of the cache controller 522. Since the color difference of a pattern is usually progressive and continuously, the neighboring color data similar to the required color data can be loaded simultaneously to minimize the number of loading, so that the efficiency of the cache can be enhanced.

74: Sending back the color data 56 corresponding to the color index 54, thereafter, the process ends. That is, when the color data 56 which matches with the color index 54 does exist in the cache 52, the color data 56 will be send back to the color processor 51, and thereafter the process ends.

Here a detailed discussion about “hit rate” is provided. The definition of hit rate is the percentage representing the number of times that the built-in memory 521 of the cache 52 is able to provide the required color data to the color processor 52, i.e. (hit rate)=(the number of times that the cache is able to provide the required color data to the color processor)/(the total requests of the color processor)×100%. It is obvious that the number of the cache 52 capable of providing the required color data to the color processor 51 have direct impact to the hit rate, and moreover, the aforementioned number of the cache 52 is related to the design of the tag 5210 and the size of the memory 521. In the IC design, the amount of data containing in the memory 521 is proportional to the area thereof, i.e. the size of the memory 521 will have direct influence to the hit rate. However, although an overgreat memory 521 can increase the hit rate, but the wastes of precious area is not the outcome that the present invention intended. Therefore, how to choose an appropriate size of the memory 521 is an important factor for the success of the present invention. In this regard, after many experiments are carried out according to the embodiment of the present invention using an 8 K-bytes cache and employing the fruit plate, which is one of the four standard images of image processing, as test media, the following data are acquired: for a color table having 9×9×9×6 bytes data, it can achieve 99.999831% hit rate, and the required bandwidth is 487 bytes/sec; for a color table having 17×17×17×6 bytes data, it can achieve 99.999831% hit rate, and the required bandwidth is 57237 bytes/sec; for a color table having 33×33×33×6 bytes data, it can achieve 99.613649% hit rate, and the required bandwidth is 1112691 bytes/sec. Hence, the forgoing configuration can fit the requirement of high performance color processing.

The application of the present invention is extensive, for instance, to print an image of the video capture devices, such as digital camera, digital camcorder, etc. from a printer without the use of computer, or in a high-speed video card, 3-D image processing, etc. Those skilled in the art should appreciate that they can readily use the disclosed conception and specific embodiments as a basis for designing or modifying other structures for carrying out the same purpose of the present invention, and that various changes, substitutions and alterations can be made herein without departing from the spirit and scope of the invention as defined by the append claims.

1. A method for color processing realized by a color processing apparatus, which comprises a color table for storing a plurality of color data, and a cache memory for caching part of the color data, the method comprising the steps of:
issuing a color index;
returning at least one of the color data corresponding to the color index if the at least one of the color data is cached in the cache memory; and
returning at least one of the color data from the color table if the at least one of the color data is not cached in the cache memory.

2. The method for color processing of claim 1, wherein the color table and the cache memory are in the different devices.

3. The method for color processing of claim 1, further comprising:
writing the at least one of the color data corresponding to the color index into the cache memory from the color table if the at least one of color data is not cached in the cache memory.

4. The method for color processing of claim 3, further comprising:
writing a portion of the color data similar to the at least one of the color data corresponding to the color index into the cache memory from the color table if the at least one of the color data corresponding to the color index is not cached in the cache memory.

5. An apparatus for color processing, comprising:
a memory for storing at least a color table comprising a plurality of color data; and
a color processing module coupled to the memory, comprising:
a cache for storing at least one of the color data selected from the color table; and
a color processor, coupled to the cache, for performing color conversions and operations;
wherein the color processor issues a color index to search for a corresponding color data from the cache, and the corresponding color data is loaded from the color table into the cache if the corresponding color data is not found in the cache.

6. The apparatus for color processing of claim 5, wherein the memory is independent of the cache.

7. The apparatus for color processing of claim 5, wherein, while the corresponding color data is loaded from the memory into the cache, a portion of the color data similar to the corresponding color data are also loaded into the cache.

8. The apparatus for color processing of claim 5, wherein the cache comprises:
a cache controller, coupled to the memory, for loading the corresponding one of the color data from the memory into the cache if the corresponding color data is not found in the cache.

9. An apparatus for accelerating color processing coupled to an external color table storing a plurality of color data, comprising:
a color processor performing color conversions and operations; and
a cache coupling the color table and the color processor and storing at least one of the color data selected from the color table;
wherein the color processor issues a color index to search for a corresponding color data from the cache, and the corresponding color data is loaded from the color table into the cache if the corresponding one of the color data is not found in the cache.

10. The apparatus for accelerating color processing of claim 9, wherein the color table and the cache memory are in the different devices.

11. The apparatus for accelerating color processing of claim 9, wherein, while the corresponding color data is loaded from the color table into the cache, a portion of the color data similar to the corresponding color data are also loaded into the cache.

12. The apparatus for accelerating color processing of claim 9, wherein the cache further comprises:
a cache controller, coupled to the color table, for loading the corresponding color data from the color table into the cache if the corresponding color data is not found in the cache.
